(19) United States
(12) Patent Application Publication
(10) Pub. No.: US 2022/0001730 A1
(43) Pub. Date: Jan. 6, 2022

(54) LOCKING DEVICE FOR PICKUP TRUCK COVER

(71) Applicant: WENZHOU TIANMAO AUTO PARTS CO.,LTD, WENZHOU (CN)

(72) Inventor: LANHUA CAI, WENZHOU (CN)

(21) Appl. No.: 17/060,612

(22) Filed: Oct. 1, 2020

(30) Foreign Application Priority Data
Jul. 1, 2020 (CN) 202010619818.7

(51) Int. Cl. B60J 7/19

(52) U.S. Cl. CPC B60J 7/198

(57) ABSTRACT

The invention relates to the mechanical field, in particular to a locking device. A locking device for pickup bed cover includes a locking device, which includes a first profile and a second profile; the first profile is provided with a locking chamber assembly; the second profile is provided with a latch assembly. This invention provides the pickup bed cover a locking device with simple structure and convenient use. The easy mounting of the locking device and smooth switch improve the user's use experience.

### CROSS-REFERENCE TO RELATED APPLICATIONS

This application claims priority to Chinese Patent Application No. 202010619818.7 with a filing date of Jul. 1, 2020. The content of the aforementioned application, including any intervening amendments thereto, are incorporated herein by reference.

### TECHNICAL FIELD

This invention is relevant to mechanical field, especially about the locking device.

### BACKGROUND TECHNOLOGY

With the popularity of pickups in the market, pickups are becoming more an more common especially in the U.S. market. Since the cargo hopper is open, people design a bed cover for the pickup hopper to prevent the water from wetting the goods inside the hopper in rainy and snowy weather, the car cover is closed by the roll cover lock. Due to the car cover needs to be opened or closed time to time, the roll cover lock use frequently. However common roll up cover lock on the market now has the disadvantages of inconvenient mounting, rigid switch and strong frustration, the existing roll up cover lock can not meet the needs and even reduce the use of users experience to some extent.

### About the Invention

The purpose of the invention is to provide the pickup bed cover a locking device to solve at least one of the above technical problems.

Thus the invention use the following method:

A locking device for pickup bed cover includes a locking device, the locking device includes a longitudinally placed first profile and a horizontally placed second profile;

the first profile is provided with a locking chamber assembly;

the lock chamber assembly includes a first fixing block, the front part of the first fixing block is provided with a locking bolt groove, the middle part of the first fixed block is provided with a sliding groove, the rear part of the first fixing block is provided with a first mounting groove, the first mounting groove is provided with a first spring and a supporting plate, the supporting plate is provided with a fixed column, the first spring sleeve is arranged outside the fixed column, one end of the first spring is against the inner wall of the first mounting groove while the other end is against the supporting plate, the supporting plate is connected with the first profile;

the second profile is provided with a lock latch assembly;

the lock latch assembly includes a second fixed block, the second fixed block is connected with the second profile, the front part of the second fixed block is provided with a second mounting groove and a through-hole, the through-hole is connected with the second mounting groove, the second mounting groove is provided with a lock bolt match with the bolt groove, the through-hole passes a pull rod which is connected with the lock bolt, a second spring is arranged outside the pull rod, one end of the second spring is against the lock bolt while the other end is against the inner wall of the second mounting groove, the second fixed block is provide with a first convexity which match with the sliding groove, and the cross section of the first convexity is circular.

The second fixed block is connected with an adapter whose cross section is fan-shape, the adapter is arranged between the first profile and the second profile. The supporting plate is connected with a fixed plate, the fixed plate is fixed on

the first profile by bolts;

the second profile is provided with an embedded groove, the second fixed block near the adapter is provide with a second convexity which match with the embedded groove.

The width of the sliding groove decreases gradually from the opening to the inside, the bottom surface of the sliding groove is in an arc shape.

The first fixed block is provided with a groove whose cross section is rectangular, the groove is arranged above the groove of the lock bolt, the depth of the groove is increased gradually from front to back.

The bottom surface of the sliding groove close to the second fixed block is provided with a strip-shaped convexity, the first convexity is provide with a stop ring which is used to against the strip convexity.

The pull rod include a cylindrical front rod, and a cylindrical rear rod, the front cylindrical rod is connected with the rear rod, the front cylindrical rod passes through the through hole, and the diameter of the rear cylindrical pull rod is larger than the diameter of the through-hole. The rear part of the pull rod is provided with a threading hole, a steel wire rope passes through the threading hole.

The first profile can be fixed on the side wall of the truck hopper by bolts, the second profile can be fixed on the bed cover by bolts.

When closing the pickup bed cover, the user locks the bed cover plate, the first convexity on the second fixing block first falls into the sliding groove on the first fixed block. As the bed cover is gradually closed, the second fixed block rotates with the first cylindrical convexity at a certain angle, which makes the locking bolt retract into the installation groove on the second fixed block under the pressure of the first fixed block, so that the locking bolt is clamped into the latch groove of the first fixed block to complete the closing operation of the bed cover. When opening the pickup bed cover, the user pulls the pull rod to pull the lock bolt out of the lock bolt groove and retracted into the second mounting groove on the second fixed block, then lift the bed cover upward to complete the opening operation of the bed cover.

Through this design, the invention provides the pickup truck cover a locking device, which has the advantages of simple structure and convenient use, firstly, a longitudinal damping structure formed by the first spring on the lock chamber component reduce the frustration of the locking device when locking; secondly, the clamping structure of the lock chamber assembly and the lock bolt assembly brings the locking device into effect without a lock cylinder or other complex structure, thus reduce the production cost.

### DESCRIPTION OF DRAWINGS

FIG. 1 is a partial structure illustration of this invention

FIG. 2 is a partial structure decomposition illustration of the invention;

FIG. 3 is a partial structure illustration of the lock chamber assembly in the invention;

FIG. 4 is the bottom view of the partial structure of the lock chamber assembly in the invention;

FIG. 5 is is a partial structure illustration of the lock latch assembly in the invention;

FIG. 6 is the bottom view of the partial structure of the lock latch assembly in the invention;

FIG. 7 is an use status illustration of the lock chamber assembly and the lock tongue assembly in the invention.

### THE CONCRETE METHOD TO CARRY OUT

The following instruction is to further explain the concrete implementation method of the invention.

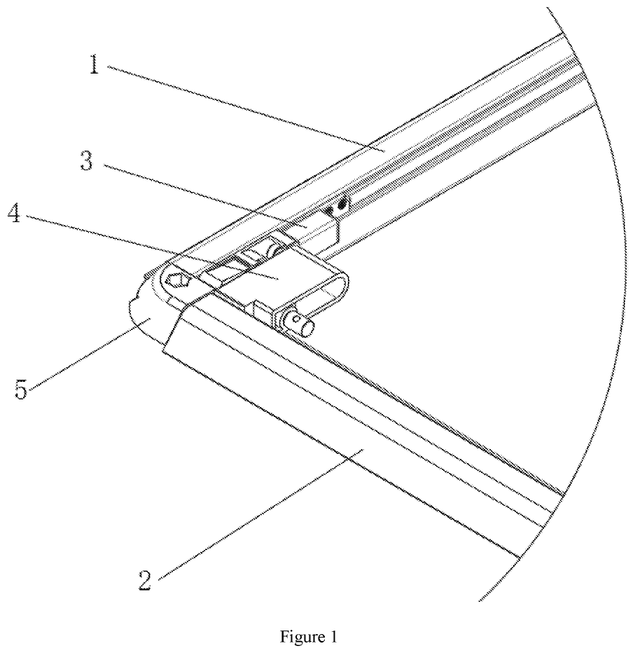

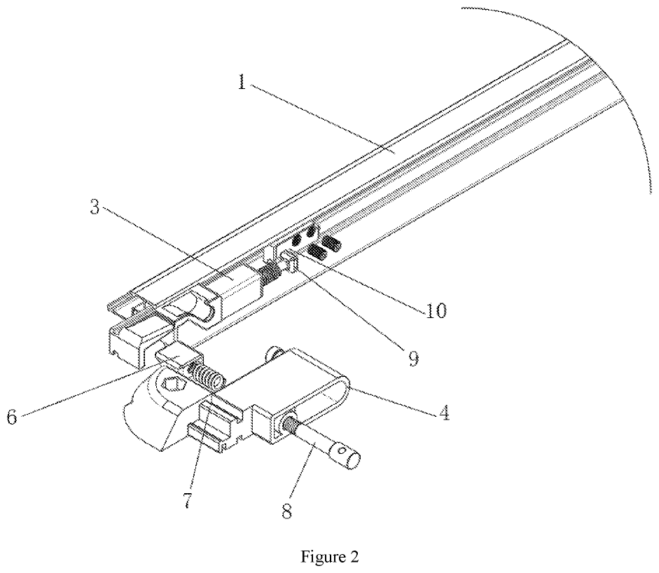

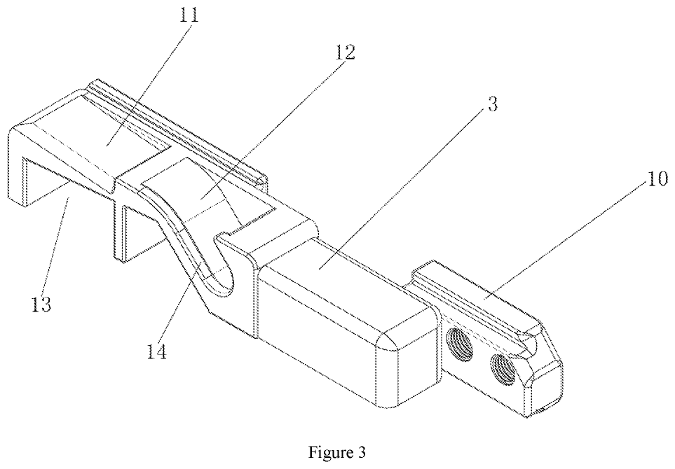

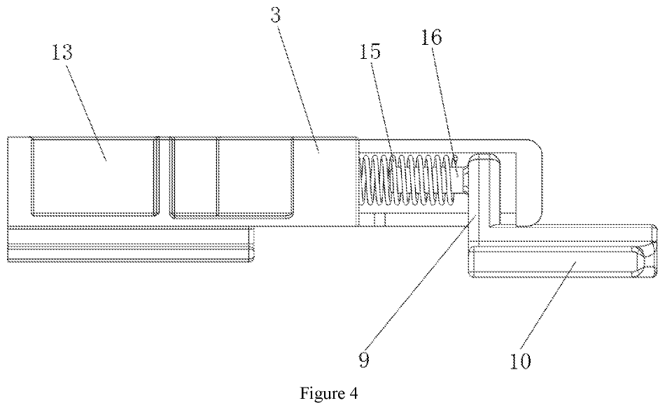

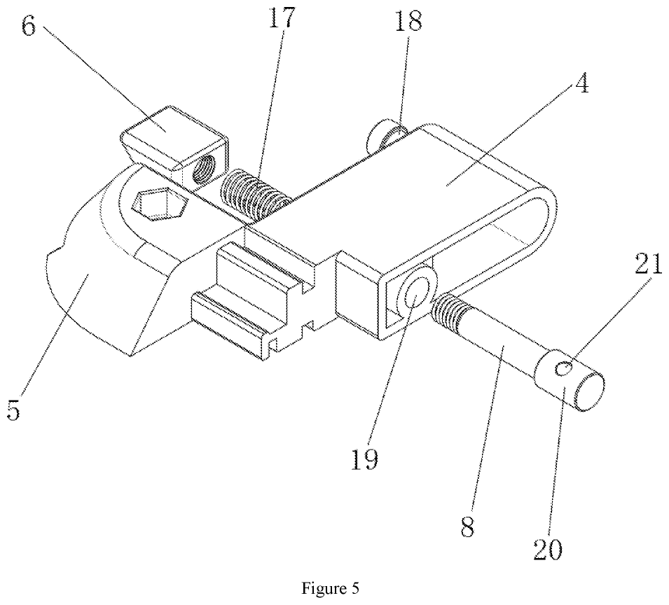

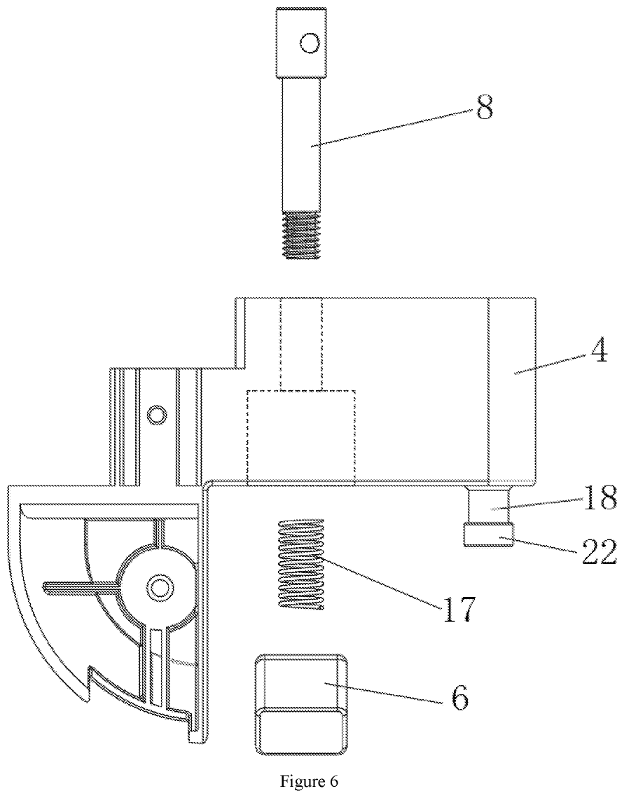

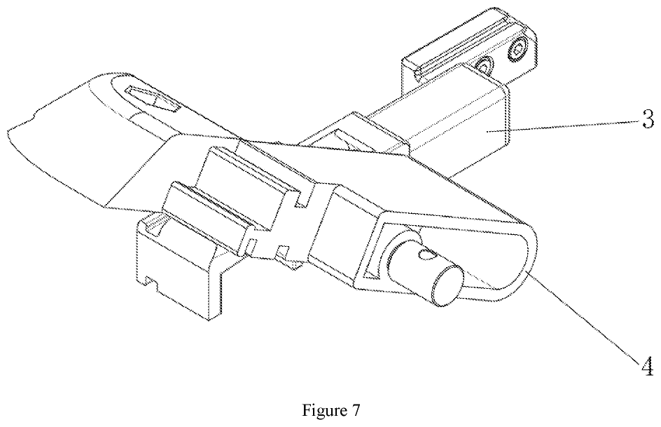

As is seen from FIGS. 1 to 7, a locking device for pickup bed cover includes a locking device, the locking device includes a longitudinally placed first profile 1 and a horizontally placed second profile2; the first profile is provided with a locking chamber assembly; the lock chamber assembly includes a first fixing block 3, the front part of the first fixing block is provided with a locking bolt groove 13, the middle part of the first fixed block is provided with a sliding groove 12, the rear part of the first fixing block is provided with a first mounting groove, the first mounting groove is provided with a first spring 15 and a supporting plate 9, the supporting plate is provided with a fixed column 16, the first spring sleeve is arranged outside the fixed column, one end of the first spring is against the inner wall of the first mounting groove while the other end is against the supporting plate, the supporting plate is connected with the first profile; the second profile is provided with a lock latch assembly; the lock latch assembly includes a second fixed block 4, the second fixed block is connected with the second profile, the front part of the second fixed block is provided with a second mounting groove and a through-hole 19, the through-hole is connected with the second mounting groove, the second mounting groove is provided with a locking bolt 6 which match with the lock bolt groove, the through-hole passes a pull rod 8 which is connected with the lock bolt, a second spring 17 is arranged outside the pull rod, one end of the second spring is against the lock bolt while the other end is against the inner wall of the second mounting groove, the second fixed block is provided with a first convexity 18 which match with the sliding groove, the cross section of the first convexity is circular. This invention provides the pickup truck cover a locking device with simple structure and convenient use, firstly, the first spring on the lock chamber assembly forms a longitudinal shock absorption structure, which can reduce the frustration of the locking device when locking; secondly, the clamping structure of the lock chamber assembly and the lock bolt assembly brings the locking device into effect without a lock cylinder or other complex structure, thus reduce the production cost; the easy mounting of the locking device and smooth switch improve the user's use experience.

When closing the pickup bed cover ,the user locks the bed cover plate, the first convexity on the second fixing block first falls into the sliding groove on the first fixed block. As the bed cover is gradually closed, the second fixed block rotates with the first cylindrical convexity at a certain angle, which makes the locking bolt retract into the installation groove on the second fixed block under the pressure of the first fixed block, so that the locking bolt is clamped into into the latch groove of the first fixed block to complete the closing operation of the bed cover. When opening the pickup bed cover, the user pulls the pull rod to pull the lock bolt out of the lock bolt groove and retracted into the second mounting groove on the second fixed block, then lift the bed cover upward to complete the cover opening operation.

In order to ensure the effect of the locking device, the first fixed block, the supporting plate, the fixed column, the second fixed block, the locking bolt, the pull rod and the first convexity are all made of stainless steel.

In order to facilitate the installation of the first profile and the second profile, the first profile can be fixed on the side wall of the truck hopper by bolts or placed on the mounting bracket of the bed cover. The second profile can be fixed on the bed cover by bolts.

The second fixed block is connected with an adapter 5 whose cross section is fan-shape, the adapter is arranged between the first profile and the second profile. The fan-shaped cross-section adapter is set at the intersection of the first profile and the second profile, two sides of the adapter fit the first profile and the second profile respectively to form a smooth transition, thus avoid the user from being injured in the collision with the corner of the first and second profile.

The supporting plate is connected with a fixed plate 10, the fixed plate is fixed on the first profile by bolts; the second profile is provided with an embedded groove, the second fixed block close to the adapter is provide a second convexity 7 which match with the embedded groove. The fixing plate is provided with two parallel first bolt holes, two second bolt holes are arranged on the first profile to match the position of the first bolt holes, the fixing plate is fixed on the first profile by a bolt passing through the first bolt hole and the second bolt hole. The supporting plate is fixed on the first profile by the fixed plate, which strengthen the longitudinal shock absorption structure,and the two parallel placed first bolt holes further improve the stability of the longitudinal shock absorption structure. Through the cooperation of the embedded groove and the second convexity, the second fixed block and the second profile formed a fixed connection, which facilitates the installation.

The width of the sliding groove decreases gradually from the opening to the inside, the bottom surface of the sliding groove is in an arc shape. When the bed cover is gradually closed, the second fixed block moves downward along with the tail of the bed cover showing a circular arc shape track, the wide opening of the sliding groove facilitates the first convexity to fall into the arc track of the sliding groove, the arc shaped bottom surface facilitates the rotation of the first convexity.

The first fixed block is provided with a groove 11 whose cross section is rectangular, the groove is arranged above the the lock bolt groove, the depth of the groove increased from front to back. When the second fixed block moves downward along with the tail of the car cover, the lock bolt squeezed out by the first fixed block and then touches the groove on the first fixed block. Since the depth of the groove deepens from front to back and the contact area between the bottom surface of the groove and the lower surface of the lock bolt is large, lock bolt is stressed evenly, thus reduces the frustration when locking and the damage of the lock tongue.

The bottom surface of the sliding groove near the second fixed block is provided with a strip-shaped convexity 14, a stop ring 22 against the strip convexity is arranged on the first convexity. The first convexity is cylindrical shape, and the cross section of the stop ring is circular, the stop ring is sets outside the first convexity. The stop ring and the first convexity formed an integrated structure. When the first convexity falls into the sliding groove, the stop ring resists the strip-shaped convexity to avoid the first convexity from sliding out, thus implement the capability of the lock latch assembly.

In order to facilitate the user pulling the pull rod to open the car cover, the pull rod include a cylindrical front rod, and a cylindrical rear rod 20, the front cylindrical rod is connected with the rear rod, the front cylindrical rod passes through the through hole, and the diameter of the rear cylindrical pull rod is larger than the diameter of the through-hole. The rear part of the pull rod is provided with a threading hole 21, a steel wire rope passes through the threading hole.The user drives the pull rod by pulling the wire rope to open the bed cover.

Finally, it should be noted that the above is only a preferred embodiment of the invention and is not used to limit the invention. Although the invention is described in detail with reference to the above embodiment, it is still possible for those skilled in the field to modify. Or they can do equivalent replacement of some of the technical features in it. Any modification, equivalent replacement, improvement etc. made within the spirit and principles of the invention shall be included in the scope of protection of the invention.

1. A locking device for pickup bed cover includes a locking device, wherein the locking device includes a longitudinally placed first profile and a horizontally placed second profile;
the first profile is provided with a lock chamber assembly;
the said lock chamber assembly includes a first fixing block, the front part of the first fixing block is provided with a locking bolt groove, the middle part of the first fixed block is provided with a sliding groove, the rear part of the first fixing block is provided with a first mounting groove, the first mounting groove is provided with a first spring and a supporting plate, the supporting plate is provided with a fixed column, the first spring sleeve is arranged outside the fixed column, one end of the first spring is against the inner wall of the first mounting groove while the other end is against the supporting plate, the supporting plate is connected with the first profile;
the second profile is provided with a lock latch assembly;
the said lock latch assembly includes a second fixed block, the second fixed block is connected with the second profile, the front part of the second fixed block is provided with a second mounting groove and a through-hole, the through-hole is connected with the second mounting groove, the second mounting groove is provided with a locking bolt which match with the bolt groove, a pull rod is connected with the lock bolt through the said through-hole, there is a second spring arranged outside the pull rod, one end of the second spring is against the locking bolt while the other end is against the inner wall of the second mounting groove, the second fixed block is provide with a first convexity which match with the sliding groove, the cross section of the first convexity is circular.

2. The locking device for pickup bed cover according to claim 1, wherein the second fixed block is connected with an adapter whose cross section is fan-shape, the adapter is arranged between the first profile and the second profile.

3. The locking device for pickup bed cover according to claim 1, wherein the supporting plate is connected with a fixed plate, the fixed plate is fixed on the first profile by bolts;
the second profile is provided with an embedded groove, the second fixed block near the adapter is provide with a second convexity which matched with the embedded groove.

4. The locking device for pickup bed cover according to claim 1, wherein the width of the sliding groove decreases gradually from the opening to the inside, the bottom surface of the sliding groove is in an arc shape.

5. The locking device for pickup bed cover according to claim 1, wherein the first fixed block is provided with a groove whose cross section is rectangular, the groove is arranged above the lock bolt groove, and the depth of the groove is increased gradually from the front to the back.

6. The locking device for pickup bed cover according to claim 1, wherein the bottom surface of the sliding groove near the second fixed block is provided with a strip-shaped convexity, the first convexity is provided with a stop ring which is used to resist the strip-shaped convexity.

7. The locking device for pickup bed cover according to claim 1, wherein the pull rod include a cylindrical front rod and a cylindrical rear rod, the cylindrical front rod is connected with the rear rod, the cylindrical front rod passes through the through hole, and the diameter of the cylindrical rear rod is larger than the diameter of the through-hole.

8. The locking device for pickup bed cover according to claim 7, wherein the rear part of the pull rod is provided with a threading hole, a steel wire rope passes through the threading hole.
